(19) United States
(12) Patent Application Publication
(10) Pub. No.: US 2015/0082021 A1
(43) Pub. Date: Mar. 19, 2015

(54) MOBILE PROXY FOR WEBRTC INTEROPERABILITY

(71) Applicant: QUALCOMM Incorporated, San Diego, CA (US)

(72) Inventors: Giridhar Dhati Mandyam, San Diego, CA (US); Arungundram Chandrasekaran Mahendran, San Diego, CA (US); Nikolai Konrad Leung, Takoma, MD (US); Thomas Towle, Naperville, IL (US)

(21) Appl. No.: 14/319,716

(22) Filed: Jun. 30, 2014

Related U.S. Application Data
(60) Provisional application No. 61/877,908, filed on Sep. 13, 2013.

(51) Int. Cl. H04L 29/06; G06F 9/54

(52) U.S. Cl. CPC H04L 63/166; G06F 9/541
USPC 713/151

(57) ABSTRACT

An example method and system for a mobile proxy for WebRTC interoperability is discussed. The method may include receiving a DTLS security handshake from a WebRTC API of a browser endpoint, negotiating an encryption mechanism through a signaling protocol with a non-WebRTC enabled endpoint, completing, using one or more hardware processors, the DTLS security handshake with the WebRTC API of the browser endpoint based on the encryption mechanism, and exchanging, through a mobile proxy, first media traffic from the browser endpoint with the non-WebRTC enabled endpoint and second media traffic from the non-WebRTC enabled endpoint with the browser endpoint. In various embodiments, if the non-WebRTC endpoint uses SDES for negotiation of the encryption mechanism, the encryption mechanism may include SDES-conveyed key information. However, if the non-WebRTC endpoint uses RTP for media exchange of the second media traffic, the encryption mechanism may correspond to a null cipher mode

### CROSS-REFERENCE TO RELATED APPLICATIONS

Pursuant to 35 U.S.C. §119(e), this application claims priority to the filing date of U.S. Provisional Patent Application 61/877,908, filed Sep. 13, 2013, which is incorporated by reference in its entirety.

### TECHNICAL FIELD

The present disclosure generally relates to real-time communications and more particularly to interoperability of a browser's WebRTC API with user endpoints not supporting DTLS for security key exchange.

### BACKGROUND

Web Real Time Communication (WebRTC) is an application programming interface (API) that enables browser to browser real time communications between end users. WebRTC allows a browser based application to access device features, such as a device's camera and/or microphone. WebRTC establishes a connection between two browser based applications and creates a secure channel for the exchange of data between the peers.

WebRTC utilizes Secure RTP (SRTP or Secure Real-Time Transport Protocol) to establish a secure media exchange between browsers. Real-Time Transport Protocol (RTP) governs the transfer of data between endpoints by defining the packet format of the data exchange. SRTP corresponds to a profile of RTP that defines the encryption and decryption of the data flow between the endpoints, for example, by establishing the cipher mode between the endpoints. Thus, SRTP requires key negotiation between two endpoints.

In order to negotiate the key information used for the SRTP session, the designers of WebRTC utilize Datagram TLS (DTLS or Datagram Transport Layer Security) to exchange key material and agree on a cipher mode. DTLS provides a protocol that enables applications to communicate securely. Thus, DTLS-SRTP corresponds to a specification utilized by WebRTC to privately determine key information and secure media exchange. DTLS-SRTP first initiates a DTLS security handshake that transmits a message to a receiving party to use SRTP as the key material and cipher mode. However, DTLS-SRTP is not widely used by other media exchange platforms. For example, Voice over IP platforms may alternatively use a key exchange mechanism based on Session Initiation Protocol (SIP) signaling (e.g., Session Description Protocol Security Descriptions (SDES) an extension of Session Description Protocol (SDP)). Thus, WebRTC may not be compatible with all media exchange platforms.

### BRIEF SUMMARY

This disclosure relates to real-time communications. Methods, systems, and techniques for executing real-time communications by a processor are provided.

According to an embodiment, a method for secure data communication between two endpoints includes receiving a Datagram Transport Layer Security (DTLS) security handshake from a Web Real Time Communication (WebRTC) application programming interface (API) of a browser endpoint and negotiating an encryption mechanism through a signaling protocol with a non-WebRTC enabled endpoint. The method further includes completing, using one or more hardware processors, the DTLS security handshake with the WebRTC API of the browser endpoint based on the encryption mechanism and exchanging, through a mobile proxy, first media traffic from the browser endpoint with the non-WebRTC enabled endpoint and second media traffic from the non-WebRTC enabled endpoint with the browser endpoint.

In another embodiment, a system for secure data communication between two endpoints includes a browser endpoint that transmits a Datagram Transport Layer Security (DTLS) security handshake using a Web Real Time Communication (WebRTC) application programming interface (API) and a mobile proxy that negotiates an encryption mechanism through a signaling protocol. The system further includes a non-WebRTC enabled endpoint that negotiates the encryption mechanism through the signaling protocol with the mobile proxy by providing the encryption mechanism supported by the non-WebRTC enabled endpoint to the mobile proxy. Additionally, the mobile proxy completes the DTLS security handshake with the WebRTC API of the browser endpoint based on the encryption mechanism and exchanges first media traffic from the browser endpoint with the non-WebRTC enabled endpoint and second media traffic from the non-WebRTC enabled endpoint with the browser endpoint.

In a different embodiment, a non-transitory computer-readable medium comprising instructions which, in response to execution by a computer system, cause the computer system to perform a method including receiving a Datagram Transport Layer Security (DTLS) security handshake from a Web Real Time Communication (WebRTC) application programming interface (API) of a browser endpoint and negotiating an encryption mechanism through a signaling protocol with a non-WebRTC enabled endpoint. The method further includes completing the DTLS security handshake with the WebRTC API of the browser endpoint based on the encryption mechanism and exchanging, through a mobile proxy, first media traffic from the browser endpoint with the non-WebRTC enabled endpoint and second media traffic from the non-WebRTC enabled endpoint with the browser endpoint.

In another embodiment, a system includes a non-transitory memory storing a mobile proxy and one or more hardware processors in communication with the non-transitory memory and configured to execute the mobile proxy to receive a Datagram Transport Layer Security (DTLS) security handshake from a Web Real Time Communication (WebRTC) application programming interface (API) of a browser endpoint, negotiate an encryption mechanism through a signaling protocol with a non-WebRTC enabled endpoint, complete the DTLS security handshake with the WebRTC API of the browser endpoint based on the encryption mechanism, and exchange, through the mobile proxy, first media traffic from the browser endpoint with the non-WebRTC enabled endpoint and second media traffic from the non-WebRTC enabled endpoint with the browser endpoint.

### BRIEF DESCRIPTION OF THE DRAWINGS

The accompanying drawings, which form a part of the specification, illustrate embodiments of the invention and together with the description, further serve to explain the principles of the embodiments. In the drawings, like reference numbers may indicate identical or functionally similar elements.

FIG. 1 is a block diagram illustrating a system for executing real-time communication between a WebRTC enabled endpoint and a non-WebRTC enabled endpoint, according to an embodiment.

FIG. 2 is a block diagram of a mobile proxy executing on a WebRTC enabled endpoint device, according to an embodiment.

FIG. 3 is a simplified flowchart illustrating a mobile proxy negotiating an encryption mechanism and exchanging media traffic between two endpoints.

FIG. 4 is a simplified flowchart illustrating a method executable by a mobile proxy for WebRTC interoperability, according to an embodiment.

FIG. 5 is a block diagram of a computer system suitable for implementing one or more components in FIG. 1, according to an embodiment.

### DETAILED DESCRIPTION OF THE DRAWINGS

It is to be understood that the following disclosure provides many different embodiments, or examples, for implementing different features of the present disclosure. Some embodiments may be practiced without some or all of these specific details. Specific examples of components, modules, and arrangements are described below to simplify the present disclosure. These are, of course, merely examples and are not intended to be limiting.

As previously discussed, WebRTC uses Datagram Transport Layer Security—Secure Real-time Transport Protocol (DTLS-SRTP) as the specification to negotiate keys information between endpoints and exchange secure media communications. Thus, a receiving endpoint must be able to handle a DTLS security handshake, which is not common between VoIP (Voice of IP), VoLTE (Voice over LTE or Voice of Long Term Evolution), and other endpoints. Moreover, it is common that VoLTE deployments, such as those for high-speed data transfer on mobile phones, use Real-time Transport Protocol (RTP) instead of Secure Real-time Transport Protocol (SRTP) for media communications. Thus, there exists a compatibility issue in SRTP encoded data being interpreted by RTP endpoints. Therefore, an endpoint utilizing WebRTC is not assured of interoperability with various VoIP and VoLTE endpoints.

Given WebRTC's mandate of DTLS-SRTP specification for the establishment of secure media channels, a mobile proxy may be utilized to provide interoperability to existing VoIP and VoLTE. A mobile proxy may execute on a device of the WebRTC enabled browser endpoint. The mobile proxy is able to receive a DTLS security handshake from a WebRTC endpoint (e.g., a browser application that utilizes the WebRTC API) and negotiate a keying mechanism for media transfer with another endpoint.

For example, the mobile proxy may receive a DTLS security handshake that includes a request to utilize STRP as the media exchange protocol. After receiving the DTLS security handshake, the mobile proxy may negotiate the keying mechanism with a non-WebRTC enabled endpoint. In various embodiments, the mobile proxy may utilize a key exchange mechanism that is based on Session Initiation Protocol (SIP) signaling to determine the keying mechanism. Such a key exchange mechanism may correspond to Session Description Protocol Security Descriptions (SDES). However, in endpoints that require RTP instead of SRTP, the mobile proxy may negotiate a null cipher mode with the non-WebRTC enabled endpoint. Thus, the mobile proxy may negotiate SDES conveyed key information or establish a null cipher mode based on the requirement of the connection. In other embodiments, different key exchange and/or cipher modes may be utilized.

Once the key encryption mechanism is negotiated with the non-WebRTC enabled endpoint, the mobile proxy may complete the DTLS security handshake with the WebRTC endpoint using the encryption mechanism. Thus, if the mobile proxy negotiated SDES-conveyed key information (or through another key exchange mechanism), the key information may be passed through the DTLS security handshake as the key information for use when exchanging STRP media. In other embodiments where the non-WebRTC enabled endpoint utilizes RTP for media transfer, the mobile proxy may negotiate a null cipher with the WebRTC endpoint since a null cipher is a supported cipher mode for SRTP.

Once a DTLS security handshake is completed with the WebRTC endpoint and a connection is established with the non-WebRTC enabled endpoint, media data transfer may occur through the mobile proxy. The mobile proxy may buffer media from the non-WebRTC enabled endpoint that is incoming prior to completion of the DTLS security handshake with the WebRTC enabled endpoint. In various embodiments, the mobile proxy may also translate SRTCP traffic to RTCP traffic for endpoints requiring the use of plain RTP.

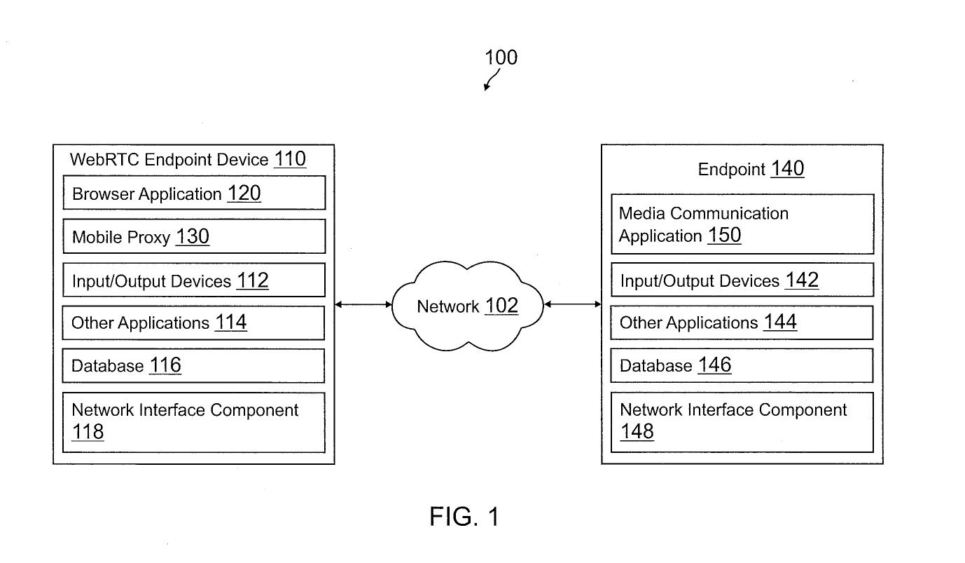

FIG. 1 is a block diagram illustrating a system for executing real-time communication between a WebRTC enabled endpoint and a non-WebRTC enabled endpoint, according to an embodiment. As shown, system 100 may comprise or implement a plurality of devices, servers, and/or software components that operate to perform various methodologies in accordance with the described embodiments. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a network 102, a WebRTC endpoint device 110, and an endpoint 140. WebRTC endpoint device 110 and endpoint 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 102. Thus, in various embodiment, WebRTC endpoint 110 and endpoint 140 may be implemented as a personal computer (PC), a smart phone, laptop computer, wristwatch with appropriate computer hardware, eyeglasses with appropriate computer hardware (e.g. GOOGLE GLASS®) and/or other types of computing devices capable of transmitting and/or receiving data, such as an IPAD® from APPLE®. Although in environment 100 single devices are shown, WebRTC endpoint device 110 and endpoint 140 may correspond to a plurality of devices that may function similarly.

WebRTC endpoint device 110 includes a browser application 120, a mobile proxy 130, input/output devices 112, other application 114, a database 116, and a network interface component 118. WebRTC endpoint device 110 may execute a WebRTC based web application in browser application 120 in order to communicate with a separate user endpoint, such as endpoint 140. As previously discussed, WebRTC provides a browser based application programming interface (API) that enables peer to peer media communications. Thus, the WebRTC API requires the establishment of a secure media channel and a trustworthy key exchange mechanism.

WebRTC endpoint device 110 includes browser application 120. Browser application 120 may be utilized by a user to establish, access, and maintain a connection with one or more websites including web applications. For example, browser application 120 may be utilized to connect to a website and to execute a web application of the website. Additionally, browser application 120 may include an application (e.g., processes and procedures within browser application 120) that enable browser-to-browser communications. Such media exchange through browser application 120 may be effectuated utilizing a WebRTC API.

Thus, a WebRTC enabled application executed through browser application 120 requires establishing secure data communication with a second endpoint, such as endpoint 140. In order to establish the secure data communication, negotiation of session parameters occurs, including negotiation of the data encryption keys between the endpoints or use of a null cipher. Thus, browser application 120 may initiate a security handshake in an attempt to negotiate the session parameters. When utilizing the WebRTC API to attempt browser-to-browser or other browser based communications, the security handshake may correspond to a DTLS security handshake. Since WebRTC utilizes DTLS-SRTP, the DTLS handshake may include a request to utilize SRTP compatible security parameters (e.g., SRTP supported key information or a null cipher).

SRTP (Secure Real-Time Transport Protocol) defines a security profile of RTP (Real-Time Transport Protocol). RTP defines a packet format for delivery of audio, video, and/or audiovisual content over an IP network. Thus, SRTP provides encryption and decryption of the packets during data flow, for example, establishing the ciphering algorithm. SRTP supports, as a ciphering mode, the use of a null cipher, which results in the equivalent of data exchange using RTP (essential no encryption of the data flow).

Together DTLS-SRTP includes a DTLS security handshake with a designation to use SRTP. This DTLS security handshake designates the various ciphering algorithms supported by the originator of the DTLS security handshake. A second endpoint may reply to the DTLS if the second endpoint supports DTLS-SRTP by treating the DTLS handshake through designating its support of SRTP and indicating an agreed upon ciphering mode.

However, in FIG. 1, endpoint 140 may not be able to treat a DTLS handshake. For example, if endpoint 140 is a non-WebRTC enabled endpoint, the DTLS handshake initiated by browser application 120 may not be able to be treated by endpoint 140. Thus, mobile proxy 130 may be required to exchange media between WebRTC endpoint device 110 and endpoint 140.

WebRTC endpoint device 110 may receive data, such as voice and/or video media from a user of WebRTC endpoint device 110. WebRTC endpoint device 110 may include a microphone, video camera, or other data input/output component to enable the capture of data. In various embodiments, one or more of input/output devices 112 may be activated by a WebRTC based web application executing in browser application 120. Once the WebRTC based web application is activated, WebRTC endpoint device 110 may attempt to establish communication with endpoint 140.

Thus, the DTLS handshake is instead transmitted to mobile proxy 130. Mobile proxy 130 corresponds to procedures, including hardware necessary to execute the procedures, to complete the DTLS handshake using an encryption mechanism negotiated with endpoint 140. After receiving the DTLS handshake, mobile proxy 130 may attempt to negotiate the encryption mechanism with endpoint 140.

Mobile proxy 130 may check if endpoint 140 supports SDES for key negotiation. Since SDES-conveyed key information is compatible with SRTP and allows for key negotiation for SRTP sessions, mobile proxy 130 may attempt to negotiate the key information using SDES. SDES utilizes SIP signaling, which may be utilized by endpoint 140, for example, if endpoint 140 corresponds to a VoIP endpoint. However, in other embodiments, mobile proxy 130 may utilize another key exchange mechanism. Once mobile proxy 130 determines the key exchange mechanism, mobile proxy 130 may negotiate the encryption mechanism between WebRTC endpoint device 110 and endpoint 140. If mobile proxy 130 utilizes SDES to negotiate the encryption mechanism, the encryption mechanism may correspond to SDES conveyed key information.

Mobile proxy 130 may also determine that endpoint 140 does not accept SRTP encoded traffic (e.g., does not encrypt/decrypt data using SRTP). For example, endpoint 140 may support RTP traffic instead. In such embodiments, mobile proxy 130 may instead negotiate a null cipher mode as the encryption mechanism for WebRTC endpoint device 110 and endpoint 140. A null cipher mode is supported by STRP and may allow mobile proxy 130 to negotiate the encryption mechanism with an endpoint that does not support SRTP key mechanisms.

Once the encryption mechanism is determined (e.g., negotiated between WebRTC endpoint device 110 and endpoint 140), mobile proxy may complete the DTLS handshake using the encryption mechanism. When completing the DTLS handshake, mobile proxy 130 utilizes the encryption mechanism to set the encryption for the SRTP session requested by browser application 120 when browser application 120 initiated the DTLS handshake. Thus, when mobile proxy 130 completes the DTLS handshake, mobile proxy 130 may pass the SDES negotiated key information (or the key information negotiated using another key exchange mechanism) through the DTLS handshake. If a null cipher mode was negotiated, then mobile proxy 130 may negotiate a null cipher mode with browser application 120.

After completing the DTLS handshake, mobile proxy 130 may exchange media data between WebRTC endpoint device 110 and endpoint 140. Endpoint 140 may begin transmitting media data as soon as the encryption mechanism is negotiated with mobile proxy 130. In certain embodiments, endpoint 140 may begin transmitting media data as soon as a SIP 200 OK signaling message is transmitted to mobile proxy 130, as will be explained in more detail herein. Thus, mobile proxy 130 may buffer incoming data from endpoint 140 prior to transmission to browser application 120 (e.g., while mobile proxy 130 completes the DTLS handshake). Once the DTLS handshake is completed, the media content from endpoint 140 may be provided to browser application 120.

Additionally, after completion of the DTLS handshake, browser application 120 may begin transmitting media content to mobile proxy 130. The media content transmitted by browser application 120 may also be buffered by mobile proxy 130 prior to transmission to endpoint 140, or may be transmitted to endpoint 140 as soon as the media content is received. The media traffic from browser application 120 may correspond to SRTCP media content. Thus, in embodiments where endpoint 140 supports RTP and not SRTP, mobile proxy 140 may translate the SRTCP media content to RTCP media content for use by endpoint 140 supporting plain RTP.

Input/output devices 112 may correspond to devices enabling a user (not shown) of WebRTC endpoint device 110 to input information to browser application 120 and/or other application 114 and receive output from browser application 120 and/or other applications 114. Thus, input/output devices 112 may correspond to one or more displays, keyboards, computer mice, touchscreens, cameras and other optical devices, microphones/speakers and other audio devices, etc. Input/output devices 112 may be utilized during the course of communications through browser application 120.

WebRTC endpoint device 110 includes other applications 114 as may be desired in particular embodiments to provide features to WebRTC endpoint device 110. For example, other applications 114 may include security applications for implementing client-side security features, programmatic client applications for interfacing with appropriate application programming interfaces (APIs) over network 102, or other types of applications. Other applications 114 may include applications for use with input/output device 112, such as camera applications, sound/microphone applications, etc. Additionally, other applications 114 may include social media applications. Other applications 114 may contain other software programs, executable by a processor, including a graphical user interface (GUI) configured to provide an interface to the user

Database 116 may correspond to data encryption keys corresponding to the cipher used to encode data. Database 116 may be utilized by mobile proxy 130 in conjunction with endpoint 140 to establish the ciphering mode to be used between endpoints, for example, determining cryptographic algorithms enabling the encryption and decryption of data. However, in various embodiments, a null cipher mode may be negotiated at the time of a security handshake. Thus, database 116 may not be used where a null cipher mode is employed. Database 116 may include other information including identifiers such as operating system registry entries and/or cookies. Database 116 may further include user information and/or user account information for a user of WebRTC endpoint device 110.

WebRTC endpoint device 110 includes network interface component 118 adapted to communicate with endpoint 140 over network 102. In various embodiments, network interface component 118 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Endpoint 140 includes a media communication application 150, input/output devices 142, other application 144, a database 146, and a network interface component 148. Endpoint 140 may correspond to an endpoint including processor(s) and memory configured to execute media communication application 150 in order to communicate with a separate user endpoint using WebRTC based application, such as WebRTC endpoint device 110. As previously discussed, WebRTC provides a browser based application programming interface definition to enable peer to peer media communications. Thus, WebRTC requires the establishment of a secure media channel and a trustworthy key exchange mechanism, where an iteration of the encryption mechanism may be included in database 146 of endpoint 140.

As previously discussed, media communication application 150 may correspond to a media communication application that does not support WebRTC. For example, media communication application 150 may correspond to a VoIP, VoLTE, VoBB (Voice over Broadband) or other communication application enabling communication of audio, video, and/or audiovisual content over a network. Thus, without support for DTLS-SRTP, media communication application 150 may not establish a data flow with WebRTC endpoint device 110.

In various embodiments, media communication application 150 may support SDES, which acts as an extension of SDP enabling key negotiation for SRTP based media communication. SDP is well defined and used for SIP deployments used in various media exchange applications, such as VoIP applications. However, in WebRTC-capable browsers running WebRTC based web applications (e.g, browser application 120), SDES may not be utilized for exchange of key information because key information using SDES may be exposed to Javascript.

Thus, in order to exchange key information in database 146 with WebRTC endpoint device 110, mobile proxy 120 may be utilized as previously discussed. Mobile proxy 120 may enable the exchange of key information between WebRTC endpoint device 110 and endpoint 140 by negotiating an encryption mechanism for use by WebRTC endpoint device 110 and endpoint 140. Media communication application 150 may respond to a request to negotiate an encryption mechanism with a supported encryption mechanism, such as key information available in database 146 and/or a null cipher mode. Media communication application 150 may support SIP signaling, for example, through negotiation of key information using SDES. Once the encryption mechanism is negotiated, media communication application may begin transmitting media content to mobile proxy 120.

In various embodiments, where media communication application 150 utilizes SIP signaling to negotiate the encryption mechanism (e.g., SDES), media communication application 150 may begin transmitting the media content as soon as a SIP 200 OK message is transmitted by media communication application 150 in response to a SIP invite message. Thus, because the SIP 200 OK message is often conveyed through SIP proxies to mobile proxy 120, the media content may arrive at mobile proxy 120 prior to completion of negotiation of the encryption mechanism. This occurs in certain circumstances since the media content is not passed through the SIP proxies but instead directly to mobile proxy 130. Thus, mobile proxy 130 may buffer the media content.

Input/output devices 142 may correspond to devices enabling a user (not shown) of endpoint 140 to input information to media communication application 150 and/or other application 144 and receive output from media communication application 150 and/or other applications 144. Thus, input/output devices 142 may correspond to one or more displays, keyboards, computer mice, touchscreens, cameras and other optical devices, microphones/speakers and other audio devices, etc. Input/output devices 142 may be utilized during the course of a browser based communication through media communication application 150.

Endpoint 140 includes other applications 144 as may be desired in particular embodiments to provide features to endpoint 144. For example, other applications 144 may include security applications for implementing client-side security features, programmatic client applications for interfacing with appropriate application programming interfaces (APIs) over network 102, or other types of applications. Other applications 144 may include applications for use with input/output device 142, such as camera applications, sound/microphone applications, etc. Additionally, other applications 144 may include social media applications. Other applications 144 may contain other software programs, executable by a processor, including a graphical user interface (GUI) configured to provide an interface to the user.

Database 146 may correspond to data encryption keys corresponding to the cipher used to encode data. Database 146 thus may be utilized by mobile proxy 130 in conjunction with endpoint 140 to establish the ciphering mode to be used between endpoints, for example, to determine cryptographic algorithms enabling the encryption and decryption of data. However, in various embodiments, a null cipher mode may be negotiated at the time of a security handshake. Thus, database 116 may not be used where a null cipher mode is employed. Database 116 may include other information including identifiers such as operating system registry entries, cookies. Database 116 may further include user information and/or user account information for a user of WebRTC endpoint device 110.

Additionally, endpoint 140 includes network interface component 148 adapted to communicate with WebRTC endpoint device 110 over network 102. In various embodiments, network interface component 136 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 102 may be implemented as a single network or a combination of multiple networks. For example, in various embodiments, network 102 may include the Internet or one or more intranets, landline networks, wireless networks, and/or other appropriate types of networks. Thus, network 102 may correspond to small scale communication networks, such as a private or local area network, or a larger scale network, such as a wide area network or the Internet, accessible by the various components of system 100.

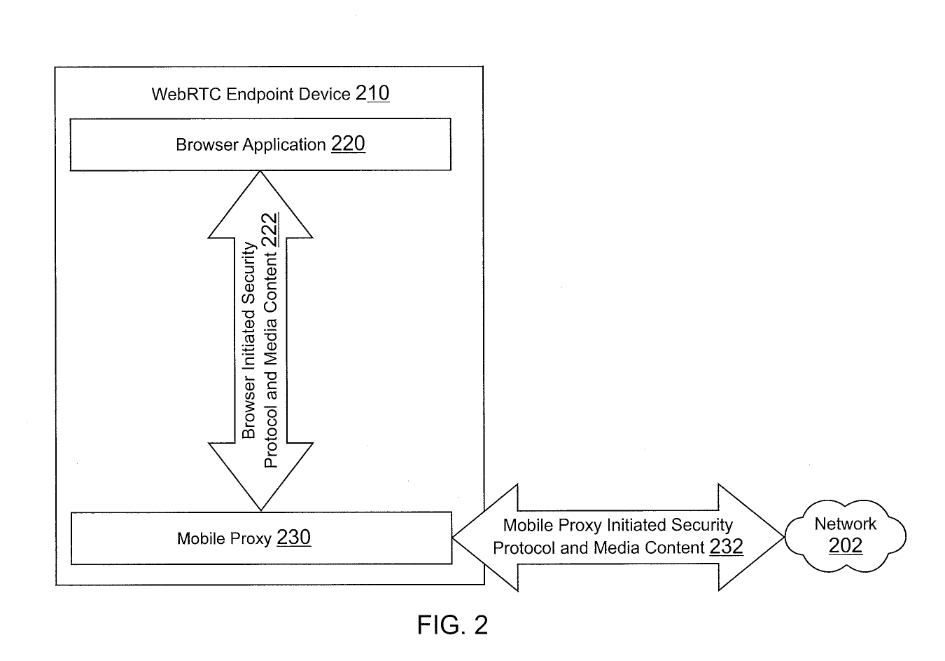

FIG. 2 is a block diagram of a mobile proxy executing on a WebRTC enabled endpoint device, according to an embodiment. FIG. 2 includes a WebRTC endpoint device 210 corresponding generally to WebRTC endpoint device 110 of FIG. 1. Moreover, WebRTC endpoint device 210 includes a browser application 220 and a mobile proxy 230 corresponding generally to the described features and functions of browser application 120 and mobile proxy 130, respectively, of FIG. 1.

FIG. 2 displays an exemplary communication by a media proxy when negotiating an encryption mechanism between a WebRTC enabled endpoint and a non-WebRTC enabled endpoint and exchanging media content. Thus, as shown in FIG. 2, WebRTC endpoint device 210 includes a browser application 220 that corresponds to a browser executing a browser communication program that utilizes WebRTC as the API for communications. Browser application 220 thus requires the use of DTLS-SRTP for negotiation of key information for use in the SRTP session.

Mobile proxy 230 of FIG. 2 thus receives browser initiated security protocol and media content 222 from browser application 220. Browser initiated security protocol and media content 222 may correspond to a DTLS handshake and SRTP media. As previously discussed, mobile proxy 230 first receives the DTLS handshake for use in negotiating the encryption mechanism for SRTP media exchange.

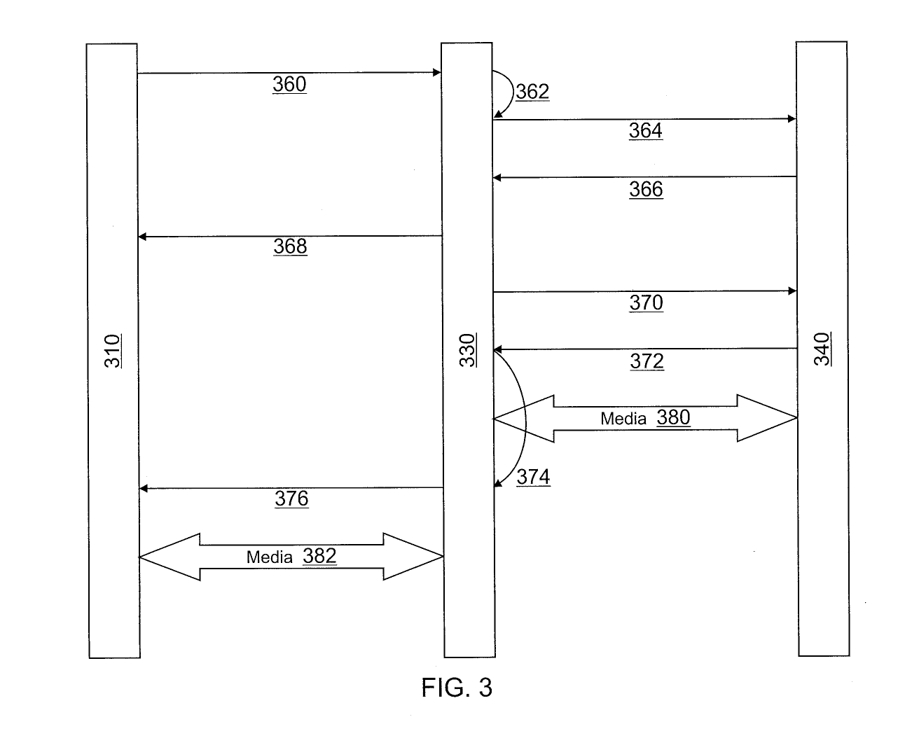

Thus, mobile proxy 230 transmits mobile proxy initiated security protocol and media content 232 over network 202. Mobile proxy initiated security protocol and media content 232 may correspond to SDES negotiated key information and/or a null cipher mode as well as SRTP media or RTCP media translated from SRTCP media where an endpoint supports RTP. Thus, mobile proxy initiated security protocol and media content 232 is negotiated and exchanged over network 202. The steps to negotiation and exchange of browser initiated security protocol and media content 222 and mobile proxy initiated security protocol and media content 232 is explained in more detail with respect to FIG. 3.

FIG. 3 is a simplified flowchart illustrating a mobile proxy negotiating an encryption mechanism and exchanging media traffic between two endpoints. FIG. 3 includes an endpoint 310 and an endpoint 340 corresponding generally to WebRTC endpoint device 110 and endpoint 140, respectively, of FIG. 1. Moreover, FIG. 3 includes a mobile proxy 330 corresponding generally to the described features and functions of mobile proxy 130 of FIG. 1.

Endpoint 310 transmits a DTLS handshake at 360. The DTLS handshake may be transmitted by a WebRTC API of a browser application on endpoint 310. The DTLS handshake is initiated with mobile proxy 330 and may include a request to utilize SRTP for media transfer. Thus, the DTLS handshake may request that the encryption/key mechanism used for media transfer as an SRTP supported encryption/key mechanism. Therefore, the encryption/key mechanism may include key information and/or a null cipher mode. Once the DTLS handshake is transmitted to mobile proxy 330, mobile proxy 330 may begin negotiating an encryption mechanism with endpoint 340.

If mobile proxy 330 determines endpoint 340 supports SRTP for media transfer, mobile proxy 330 may utilize SDES for negotiating the encryption mechanism at 362. Thus, mobile proxy 330 may negotiate the encryption mechanism using SDES and thus received SDES-conveyed key information. However, if mobile proxy 330 determines endpoint 340 supports plain RTP for media transfer, mobile proxy 330 may instead negotiate a null cipher for the encryption mechanism.

Thus, at 364, mobile proxy sends an invitation for media exchange. The invitation may correspond to a SIP signaling invite. At 366, mobile proxy 330 receives a message from endpoint 340 that the end user is alerted of the invite, such as a ringing message. Similarly, a message at 368 is sent back to endpoint 310 to alert the user of endpoint 310. A provisional acknowledgement may be transmitted to endpoint 340 at 370, which may be responded to with an OK message at 372 that corresponds to an acceptance of the request.

Once endpoint 340 has been contacted, endpoint 340 may begin transmitting media 380 to mobile proxy 330. As previously discussed, since mobile proxy 330 has not yet completed negotiating the encryption mechanism with endpoint 310 after determining the encryption mechanism to use with endpoint 340, mobile proxy 330 may buffer media 380. Thus, at 374, mobile proxy 330 negotiates a null cipher with endpoint 310 or passes the SDES-conveyed key information through the DTLS handshake. After completion of negotiation of the encryption mechanism with endpoint 310, the DTLS handshake is completed at 376. Once the DTLS handshake is completed at 376 and the encryption mechanism is passed to endpoint 310, media 382 may be transmitted to mobile proxy 330. In the case where a null cipher was negotiated as the encryption mechanism for use with endpoint 340 when endpoint 340 supports plain RTP, mobile proxy 330 may translate SRTCP media in media 382 to RTCP media for endpoint 340.

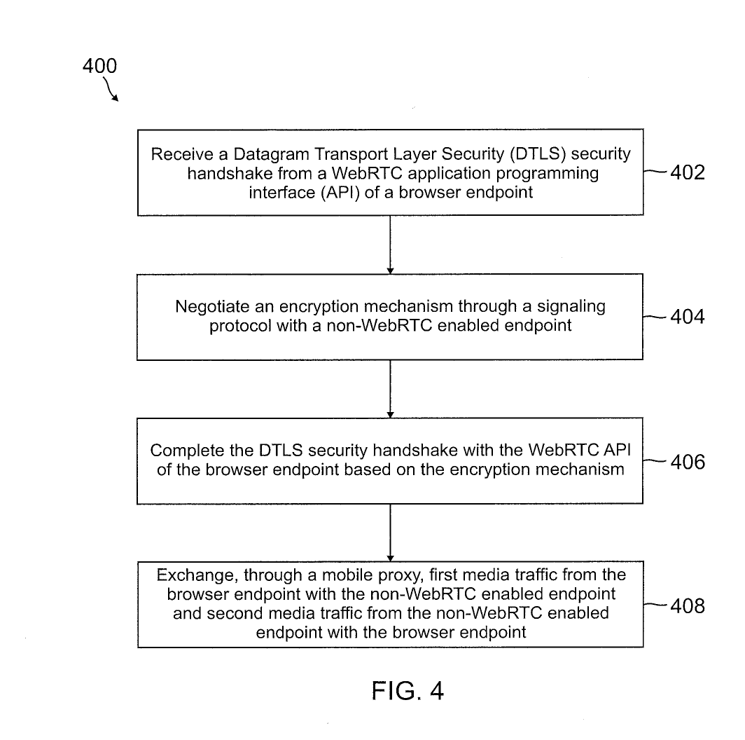

FIG. 4 is a simplified flowchart illustrating a method executable by a mobile proxy for WebRTC interoperability, according to an embodiment. Note that one or more steps, processes, and methods described herein may be omitted, performed in a different sequence, or combined as desired or appropriate.

At step 402, a Datagram Transport Layer Security (DTLS) security handshake is received from a Web Real Time Communication (WebRTC) application programming interface (API) of a browser endpoint. A mobile proxy may receive the DTLS security handshake. The DTLS security handshake may comprise a request to use Secure Real-Time Transport Protocol (SRTP) for the first media traffic.

An encryption mechanism is negotiated through a signaling protocol with a non-WebRTC enabled endpoint, at step 404. The signaling protocol may comprise Session Initiation Protocol (SIP). The mobile proxy may further determine the non-WebRTC endpoint uses Session Description Protocol Security Descriptions (SDES) for negotiation of the encryption mechanism. Thus, the encryption mechanism may comprise SDES-conveyed key information. In other embodiments, the mobile proxy may further determine the non-WebRTC endpoint uses Real-time Transport Protocol (RTP) for media exchange of the second media traffic. Thus, the encryption mechanism may comprise a null cipher mode.

At step 406, the DTLS security handshake is completed with the WebRTC API of the browser endpoint based on the encryption mechanism. At step 408, first media traffic is exchanged from the browser endpoint with the non-WebRTC enabled endpoint by the mobile proxy and second media traffic is exchanged from the non-WebRTC enabled endpoint with the browser endpoint. The first media traffic and the second media traffic may comprise Secure Real-Time Transport Protocol (SRTP) traffic. However, in other embodiments where the non-WebRTC enabled endpoint uses plain RTP for media exchange, the first media traffic may comprise Secure RTP Control Protocol (SRTCP) traffic and the second media traffic may comprise RTP Control Protocol (RTCP) traffic. Thus, the mobile proxy may further translate SRTCP traffic to RTCP traffic.

In certain embodiments, the first media traffic may comprise SRTP traffic, and the second media traffic may comprise RTP traffic. The mobile proxy may further translate the SRTP traffic to the RTP traffic. Additionally, the mobile proxy may further buffer the first media traffic and the second media traffic. For example, the second media traffic may be received by the mobile proxy prior to the first media traffic. Thus, the mobile proxy may buffer the second media traffic prior to the mobile proxy exchanging the second media traffic with the browser endpoint.

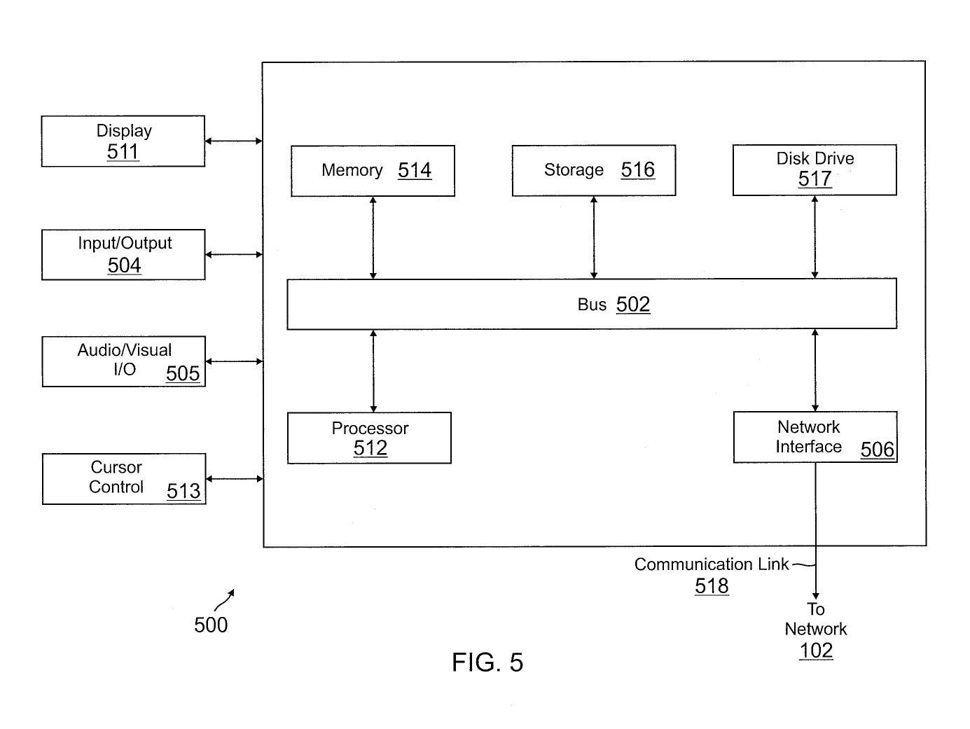

FIG. 5 is a block diagram of a computer system 500 suitable for implementing one or more embodiments of the present disclosure. In various embodiments, the endpoint may comprise a personal computing device (e.g., smart phone, a computing tablet, a personal computer, laptop, PDA, Bluetooth device, key FOB, badge, etc.) capable of communicating with the network. The merchant server and/or service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals and/or use visual input by recording video signals. Audio/visual I/O component 505 may allow the user to hear audio. A transceiver or network interface 506 transmits and receives signals between computer system 500 and other devices, such as another endpoint, a merchant server, or a service provider server via network 102.

As previously discussed, network 102 may be implemented as a single network or a combination of multiple networks. For example, in various embodiments, network 102 may include the Internet or one or more intranets, landline networks, wireless networks, and/or other appropriate types of networks. Thus, network 102 may correspond to small scale communication networks, such as a private or local area network, or a larger scale network, such as a wide area network or the Internet, accessible by computer system 500, for example the various components of system 100 of FIG. 1.

In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The previous description of the disclosed embodiments is provided to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims. Thus, the present disclosure is limited only by the claims.

What is claimed is:

1. A system for secure data communication between two endpoints, the system comprising:
a browser endpoint that transmits a Datagram Transport Layer Security (DTLS) security handshake using a Web Real Time Communication (WebRTC) application programming interface (API);
a mobile proxy that negotiates an encryption mechanism through a signaling protocol; and
a non-WebRTC enabled endpoint that negotiates the encryption mechanism through the signaling protocol with the mobile proxy by providing the encryption mechanism supported by the non-WebRTC enabled endpoint to the mobile proxy,
wherein the mobile proxy completes the DTLS security handshake with the WebRTC API of the browser endpoint based on the encryption mechanism and exchanges first media traffic from the browser endpoint with the non-WebRTC enabled endpoint and second media traffic from the non-WebRTC enabled endpoint with the browser endpoint.

2. The system of claim 1, wherein the signaling protocol comprises Session Initiation Protocol (SIP).

3. The system of claim 2, wherein the DTLS security handshake comprises a request to use Secure Real-Time Transport Protocol (SRTP) for the first media traffic.

4. The system of claim 3, wherein the mobile proxy further determines the non-WebRTC endpoint uses Session Description Protocol Security Descriptions (SDES) for negotiation of the encryption mechanism.

5. The system of claim 4, wherein the encryption mechanism comprises SDES-conveyed key information.

6. The system of claim 5, wherein the first media traffic and the second media traffic comprise Secure Real-Time Transport Protocol (SRTP) traffic.

7. The system of claim 3, wherein the mobile proxy further determines the non-WebRTC endpoint uses Real-time Transport Protocol (RTP) for media exchange of the second media traffic.

8. The system of claim 7, wherein the encryption mechanism comprises a null cipher mode.

9. The system of claim 8, wherein the first media traffic comprises Secure RTP Control Protocol (SRTCP) traffic, and wherein the second media traffic comprises RTP Control Protocol (RTCP) traffic.

10. The system of claim 9, wherein the mobile proxy further translates SRTCP traffic to RTCP traffic.

11. The system of claim 1, wherein the first media traffic comprises SRTP traffic, and wherein the second media traffic comprises RTP traffic.

12. The system of claim 11, wherein the mobile proxy further translates the SRTP traffic to the RTP traffic.

13. The system of claim 1, wherein the mobile proxy further buffers the first media traffic and the second media traffic.

14. The system of claim 1, wherein the second media traffic is received by the mobile proxy prior to the first media traffic, and wherein the mobile proxy further buffers the second media traffic prior to the mobile proxy exchanging the second media traffic with the browser endpoint.

15. A method for secure data communication between two endpoints, the method comprising:
receiving a Datagram Transport Layer Security (DTLS) security handshake from a Web Real Time Communication (WebRTC) application programming interface (API) of a browser endpoint;
negotiating an encryption mechanism through a signaling protocol with a non-WebRTC enabled endpoint;
completing, using one or more hardware processors, the DTLS security handshake with the WebRTC API of the browser endpoint based on the encryption mechanism; and
exchanging, through a mobile proxy, first media traffic from the browser endpoint with the non-WebRTC enabled endpoint and second media traffic from the non-WebRTC enabled endpoint with the browser endpoint.

16. The method of claim 15, wherein the signaling protocol comprises Session Initiation Protocol (SIP).

17. The method of claim 16, wherein the DTLS security handshake comprises a request to use Secure Real-Time Transport Protocol (SRTP) for the first media traffic.

18. The method of claim 17 further comprising:
determining the non-WebRTC endpoint uses Session Description Protocol Security Descriptions (SDES) for negotiation of the encryption mechanism.

19. The method of claim 18, wherein the encryption mechanism comprises SDES-conveyed key information.

20. The method of claim 19, wherein the first media traffic and the second media traffic comprise Secure Real-Time Transport Protocol (SRTP) traffic.

21. The method of claim 17 further comprising:
determining the non-WebRTC endpoint uses Real-time Transport Protocol (RTP) for media exchange of the second media traffic.

22. The method of claim 21, wherein the encryption mechanism comprises a null cipher mode.

23. The method of claim 22, wherein the first media traffic comprises Secure RTP Control Protocol (SRTCP) traffic, and wherein the second media traffic comprises RTP Control Protocol (RTCP) traffic.

24. A non-transitory computer-readable medium comprising instructions which, in response to execution by a computer system, cause the computer system to perform a method comprising:
receiving a Datagram Transport Layer Security (DTLS) security handshake from a Web Real Time Communication (WebRTC) application programming interface (API) of a browser endpoint;
negotiating an encryption mechanism through a signaling protocol with a non-WebRTC enabled endpoint;
completing the DTLS security handshake with the WebRTC API of the browser endpoint based on the encryption mechanism; and
exchanging, through a mobile proxy, first media traffic from the browser endpoint with the non-WebRTC enabled endpoint and second media traffic from the non-WebRTC enabled endpoint with the browser endpoint.

25. The non-transitory computer-readable medium of claim 24, wherein the DTLS security handshake comprises a request to use Secure Real-Time Transport Protocol (SRTP) for the first media traffic.

26. The non-transitory computer-readable medium of claim 25, wherein the method further comprises:
determining the non-WebRTC endpoint uses Session Description Protocol Security Descriptions (SDES) for negotiation of the encryption mechanism, and wherein the encryption mechanism comprises SDES-conveyed key information.

27. The non-transitory computer-readable medium of claim 25, wherein the method further comprises:
determining the non-WebRTC endpoint uses Real-time Transport Protocol (RTP) for media exchange of the second media traffic, and wherein the encryption mechanism comprises a null cipher mode.

28. A system comprising:
a non-transitory memory storing a mobile proxy; and
one or more hardware processors in communication with the non-transitory memory and configured to execute the mobile proxy to:
receive a Datagram Transport Layer Security (DTLS) security handshake from a Web Real Time Communication (WebRTC) application programming interface (API) of a browser endpoint;
negotiate an encryption mechanism through a signaling protocol with a non-WebRTC enabled endpoint;
complete the DTLS security handshake with the WebRTC API of the browser endpoint based on the encryption mechanism; and
exchange, through the mobile proxy, first media traffic from the browser endpoint with the non-WebRTC enabled endpoint and second media traffic from the non-WebRTC enabled endpoint with the browser endpoint.

29. The system of claim 28, wherein the one or more hardware processors is further configured to:
determine the non-WebRTC endpoint uses Session Description Protocol Security Descriptions (SDES) for negotiation of the encryption mechanism, and wherein the encryption mechanism comprises SDES-conveyed key information.

30. The system of claim 28, wherein the one or more hardware processors is further configured to:
determine the non-WebRTC endpoint uses Real-time Transport Protocol (RTP) for media exchange of the second media traffic, and wherein the encryption mechanism comprises a null cipher mode.
